(19) United States
(12) Patent Application Publication
(10) Pub. No.: US 2003/0214657 A1
(43) Pub. Date: Nov. 20, 2003

(54) Task scheduling and automated task performance in printers

(76) Inventor: Gary Glen Stringham, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/146,626

(22) Filed: May 14, 2002

(51) Int. Cl. B41F 1/00; G06F 15/00; B41B 1/00; G06K 1/00; B41J 1/00

(52) U.S. Cl. 358/1.1; 358/1.15

(57) ABSTRACT

Task scheduling and automated task performance includes a printer checking whether one or more tasks need to be performed by the printer, wherein each of the one or more tasks was previously scheduled. If one or more tasks need to be performed, then one of the tasks is identified and performed. According to another aspect, a printer receives a request to schedule one or more tasks to be automatically performed by the printer, and communicates task scheduling options to the requester. Task scheduling information is received from the requestor and saved for subsequent automatic performance of the scheduled tasks identified by the task scheduling information.

### TECHNICAL FIELD

This invention relates generally to printers, and more particularly to task scheduling and automated task performance in printers.

### BACKGROUND

Printer technology has been continually advancing, allowing increasingly powerful printers with increasing capabilities to be manufactured. As a result, printers have become increasingly commonplace in homes, businesses, and elsewhere throughout the world, allowing users to generate hard copies (e.g., paper copies) of documents supplied to the printers.

The increased capabilities of printers have been very beneficial—the quality of hard copies generated by printers has improved while the speed at which such hard copies can be generated has also improved. However, the increased capabilities have also created additional maintenance that should be performed on printers and status information that should be monitored. Much of this maintenance and status information monitoring can be performed automatically by the printer, however, it can be time consuming. The time necessary to perform such tasks can detract from the user-friendliness of the printer, as it may not be available for printing when a user desires it to be available. Thus, it would be beneficial to provide a way in which such tasks can be performed while reducing the user-unfriendliness of performing such tasks.

The task scheduling and automated task performance in printers described herein helps solve this problem.

### SUMMARY

Task scheduling and automated task performance in printers are described herein.

According to one aspect, a printer checks whether one or more tasks need to be performed by the printer, wherein each of the one or more tasks was previously scheduled. If one or more tasks need to be performed, then one of the tasks is identified and performed.

According to another aspect, a printer receives a request to schedule one or more tasks to be automatically performed by the printer, and communicates task scheduling options to the requestor. Task scheduling information is received from the requestor and saved for subsequent automatic performance of the scheduled tasks identified by the task scheduling information.

### BRIEF DESCRIPTION OF THE DRAWINGS

FIG. 1 illustrates an exemplary environment in which the task scheduling and automated task performance in printers can be employed.

FIG. 2 is a block diagram illustrating an exemplary printer.

FIG. 3 illustrates an exemplary printer task scheduling display.

FIG. 4 illustrates an exemplary display of current scheduled printer tasks for a printer.

FIG. 5 is a flowchart illustrating an exemplary process for scheduling printer tasks.

FIG. 6 is a flowchart illustrating an exemplary process for performing scheduled tasks.

FIG. 7 illustrates portions of an exemplary device in additional detail.

### DETAILED DESCRIPTION

Task scheduling and automated task performance in printers are described herein. A printer allows one or more tasks to be scheduled for the printer. Aside from tasks that are delayed print requests, these tasks are not the printing of documents in response to print requests received from computers. Rather, they involve other maintenance and/or status-related operations. Various types of tasks can be scheduled for the printer, and various rules can be established to define when the tasks should be performed. The printer maintains a record of these scheduled tasks and rules, and automatically performs the appropriate tasks at the appropriate times.

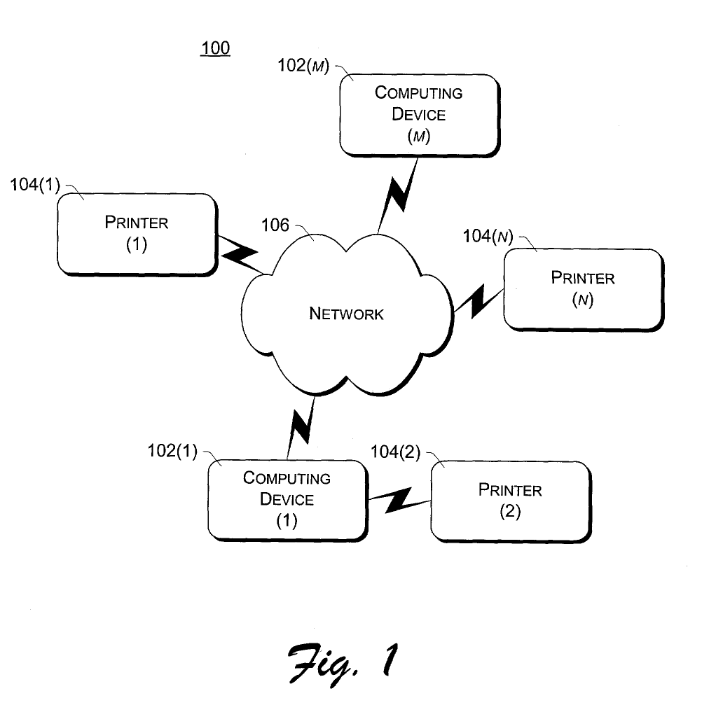

FIG. 1 illustrates an exemplary environment 100 in which the task scheduling and automated task performance in printers can be employed. In environment 100, multiple (m) computing devices 102 are coupled to one or more of multiple (n) printers 104 via a network 106 and/or directly. Network 106 is intended to represent any of a wide variety of conventional network topologies and types (including wired and/or wireless networks), employing any of a wide variety of conventional network protocols (including public and/or proprietary protocols).

Computing devices 102 can be any of a wide variety of conventional computing devices, including desktop PCs, workstations, server computers, Internet appliances, gaming consoles, handheld PCs, cellular telephones, personal digital assistants (PDAs), etc. Computing devices 102 can be the same types of devices, or alternatively different types of devices.

Printers 104 can be any of a wide variety of imaging devices capable of generating a hard copy of data (e.g., received form one of computing devices 102). Printers 104 can generate hard copies of data in any of a variety of manners, such as by using toner (e.g., in laser printers), ink (e.g., in inkjet printers, bubblejet printers, dot matrix printers, etc.), heat applied to heat-sensitive print media (e.g., thermal printers), and so forth. Printers 104 can be the same types of devices, or alternatively different types of devices. Printers 104 may also incorporate additional functionality, for example, such as the ability to scan hard copies of documents and generate digital representations of such documents, send and/or receive data as a facsimile machine, and so forth.

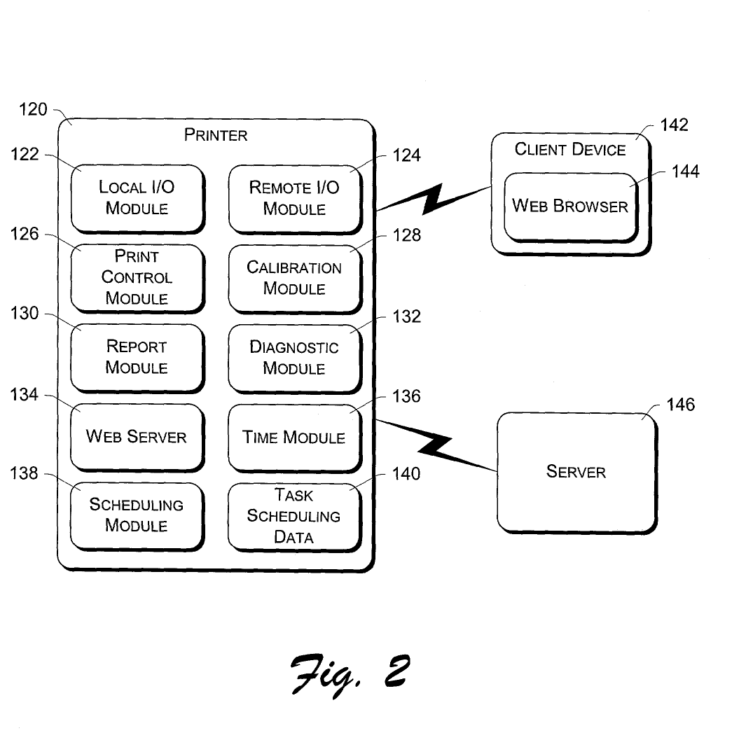

FIG. 2 is a block diagram illustrating an exemplary printer 120 in additional detail. Printer 120 can be any of printers 104 of FIG. 1. Printer 120 includes several modules or components: a local I/O module 122, a remote I/O module 124, a print control module 126, a calibration module 128, a report module 130, a diagnostic module 132, a web server 134, a time module 136, a scheduling module 138, and task scheduling data 140. The modules and components in FIG. 2 are exemplary only; the exact components included in any particular computing device can vary based on the type of device.

Local I/O module 122 controls the local input of commands and/or data to printer 120. In one implementation, printer 120 includes a display (e.g., LED screen, LCD screen, etc.) via which prompts and information can be displayed to a local user of printer 120 (e.g., a user standing at printer 120 rather than accessing printer 120 via a network), and an input mechanism (e.g., touchscreen, keypad, etc.) via which the local user can input commands and/or data to printer 120. Local I/O module 122 manages the displaying of such information or prompts, as well as the receipt of input commands and/or data and the routing of such inputs to the appropriate components of printer 120.

Remote I/O module 124 manages communication between printer 120 and one or more remote devices (e.g., via network 106 of FIG. 1). In the illustrated example, remote I/O module 124 includes a software component(s) that implements one or more commonly available network protocols, such as the well-known Transmission Control Protocol/Internet Protocol (TCP/IP). By using commonly available network protocols, a wide variety of remote devices can communicate certain information to and receive certain information from printer 120 using well-known methodologies. For example, most computing devices have a browser that communicates with other devices via the well-known HyperText Transport Protocol (HTTP) over TCP/IP. This browser can be used to access printer 120 via module 122 based on an identifier (e.g., the name, network address, Uniform Resource Locator (URL), etc.) of printer 120.

Print control module 126 manages the printing of data by printer 120 in a conventional manner in order to generate a hard copy of the data. Print requests can be received via a network (e.g., network 106 of FIG. 1) and/or directly from client computing device 142. One or more computing devices (e.g., device 142 of FIG. 2 or any of computing devices 102 of FIG. 1) can submit print requests to printer 120.

Calibration module 128 performs calibration cycles for printer 120. The exact nature of the calibration cycle can vary based on the type of printer (e.g., inkjet, laser, color, etc.) as well as on the manufacturer of the printer. In one implementation, for example, color inkjet printers are calibrated by printing lines (or other shapes) of each of the multiple colors and measuring the density of each color printed. Based on these measured densities, the printer can readily determine what proportions of what inks to use in order to generate the various colors. Such calibration cycles are well-known to those skilled in the art and thus will not be discussed further except as they pertain to the task scheduling and automated task performance in printers described herein.

Report module 130 generates status reports for printer 120 and communicates these status reports to the appropriate destination (e.g., via remote I/O module 124). The exact nature of these reports can vary based on the type of printer, the manufacturer of the printer, and the desires of the owner (or administrator) of the printer. Examples of such reports include the number of pages that have been printed, the amount of ink or toner that has been used, an amount of time the printer was in (or not in) a power-save mode, whether any errors have occurred, etc. Such status information can be generated in a variety of different manners that are well-known to those skilled in the art; thus, this status monitoring will not be discussed further except as it pertains to the task scheduling and automated task performance in printers described herein.

Diagnostic module 132 performs one or more self-diagnostic tests for printer 120. The exact nature of these tests can vary based on the type of printer as well as on the manufacturer of the printer. Examples of such tests include testing network communications, testing memory in the printer, testing any mass storage devices (e.g., hard drives) in the printer, testing the print mechanism, and so forth. Such self-diagnostic tests are well-known to those skilled in the art and thus will not be discussed further except as they pertain to the task scheduling and automated task performance in printers described herein.

Web server 134 operates as a conventional web server (e.g., conforming to the HTTP protocol). A web browser 144 of client device 142 is able to access web server 134 and load content (e.g., web pages, JavaScripts, Java applets, Virtual Basic Scripts (VBScripts), etc.) from web server 134. A conventional communication channel or connection can be established between web browser 144 and web server 134 via which such content can be transferred. In addition, information entered by a user to web browser 144 (e.g., data entry into fields of a web page, responses to queries from a JavaScript, etc.) can also be returned to web server 134 via this communication channel or connection.

Web server 134, when accessed by web browser 144, communicates task scheduling options to web browser 144. These task scheduling options allow a user of web browser 144 to identify tasks to be scheduled as well as the rules to be followed in determining when to perform the tasks. In one implementation, these task scheduling options are presented to a user of web browser 144 as a web page (e.g., written in HTML (HyperText Markup Language)).

Although printer 120 is discussed herein generally as using a web server 134, printer 120 may alternatively employ other servers that conform to other public and/or proprietary protocols. Such other protocol(s) would also be known to client device 142, allowing components of device 142 to communicate with the server(s) of printer 120.

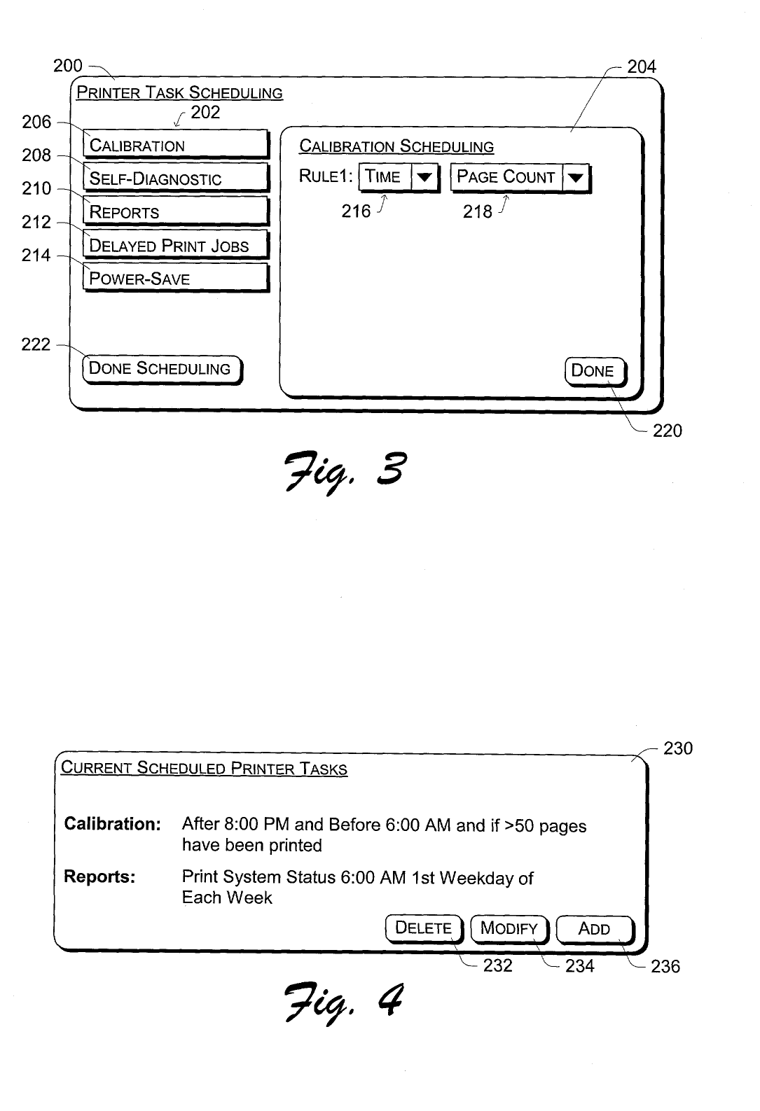

FIG. 3 illustrates an exemplary printer task scheduling display 200. Display 200 is a web page communicated from web server 134 to web browser 144. Display 200 includes multiple buttons 202 identifying different tasks that can be selected by the user for scheduling, and a rule definition window 204 in which one or more rules for the different tasks can be defined. Buttons 202 include a calibration button 206 to allow scheduling of calibration cycles, a self-diagnostic button 208 to allow scheduling of self-diagnostic tests, a reports button 210 to allow scheduling of reports, a delayed print jobs button 212 to allow scheduling of when delayed print jobs should be printed, and a power-save button 214 to allow scheduling of power-save operations. Buttons 202 are exemplary only. In alternate embodiments, additional buttons representing additional tasks may also be included, and/or one or more of buttons 206-214 may not be included. Additionally, it is to be appreciated that the layout of display 200 is exemplary only, and in alternate implementations may be organized differently.

A user, such as a system administrator, can generate one or more rules for each of the different tasks. Rule definition window 204 illustrates an exemplary display for creating a calibration scheduling rule. Each rule can have one or more conditions that need to be satisfied in order for the task to be performed by the printer. In the illustrated example, two conditions can be set by the user: a time condition 216, and a page count condition 218. The user can select from different available time ranges from a pull down menu and can also select from different available page counts via a pull down menu. Thus, the user is able to enter a rule that defines a particular time range (e.g., between 9:00 PM and 6:00 AM) and a threshold page count (e.g., greater than 75 pages), so that if more than the threshold number of pages have been printed since the last calibration cycle, and the current time is within the defined range, the printer will perform a calibration cycle. Once the user has completed entry of the rule, he or she can select the done button 220, which returns an indication of the newly defined rule to web server 134 of FIG. 2. The user can define another rule by selecting another one of the buttons 202, or another calibration rule by selecting button 206 again. Once the user has scheduled all desired tasks, he or she can select the “done scheduling” button 222, which closes display 200.

In the example of FIG. 3, the logical operator “AND” is assumed between the conditions 216 and 218. Alternatively, an additional logical operator value may be user-selectable in window 204 to allow the user to select which logical operator he or she desires. For example, the user may select from “AND”, “OR, “Exclusive-OR (XOR)”, etc.

Additionally, in the example of FIG. 3, it is assumed that only a single type of calibration cycle exists for the printer so no particular type of calibration cycle need be defined in the rule. Rather, the rule is simply associated with a “calibration” task, so scheduling module 138 knows to trigger calibration module 128 if the conditions of the rule are satisfied. However, if multiple types of calibration cycles exist for a printer, then which of those multiple types is also included as part of the rule (e.g., as a “result” portion of the rule).

It should be noted that rules can be defined using any of a wide variety of user interfaces. For example, rather than pull down menus, radio buttons may be used, check boxes may be used, data entry fields may be used, a default value may be listed and up/down arrows selected to increase/decrease the default value, and so forth.

It should also be noted that multiple rules can be defined for the same task, and that no rules may be defined for some tasks. For example, the calibration task may have multiple rules defined (e.g., different threshold page counts for different times of the day), while the reports task may have no rules defined.

A wide variety of different conditions may be used in defining the rules for a particular task. Table I illustrates exemplary tasks and conditions that may be scheduled for a printer 120. Multiple conditions are illustrated for each task—any one or more of these conditions may be used in defining a rule of the task (but a rule need not include all of these conditions), and different logical operators (e.g., AND, OR, etc.) may be employed in combining conditions. It is to be appreciated that Table I is exemplary only, and that some implementations may not employ all of the tasks or conditions shown in Table I, while other implementations may employ additional tasks or conditions.

TABLE I

| Task | Conditions |
|---|---|
| Cali- | Date: A particular day(s) or date(s) on which the task should be |
| bration | performed. |
| | Time: A particular time or time period during which the task |
| | should be performed. Times may be tied to particular dates |
| | (e.g., to allow different behavior on weekends than on |
| | weekdays). |
| | Type: Which of multiple types of calibration cycles should be |
| | performed. |
| | Resource Usage: An amount of a particular resource that should |
| | be used before performing the task (e.g., number of pages |
| | printed, or amount of ink or toner used). |
| | Criteria: Other criteria in determining whether a calibration |
| | cycle should be performed (e.g., if a certain number of pages |
| | have been printed since the last calibration cycle and a big print |
| | job is about to begin then perform a calibration cycle, if a print |
| | job has been flagged (e.g., by the user) as being of high |
| | importance then perform a calibration cycle before printing the |
| | job, whether to calibrate between pending print jobs (e.g., okay |
| | to calibrate if it's the middle of the night or if they are delayed |
| | print jobs, but not otherwise), etc.). |
| Self- | Date: A particular day(s) or date(s) on which the task should be |
| Diag- | performed. |
| nostic | Time: A particular time or time period during which the task |
| | should be performed. Times may be tied to particular dates |
| | (e.g., to allow different behavior on weekends than on |
| | weekdays). |
| | Type: Which of multiple types of self-diagnostic tests should be |
| | performed. |
| | Results: What should be done with the results of the self- |
| | diagnostic test (e.g., print the results, email the results to a |
| | particular email address, log the results to nonvolatile storage |
| | (e.g., keep the results local and available for reporting at some |
| | later time), etc.). What should be done with the results may |
| | also be conditional on what the results are (e.g., email results |
| | only if something sufficiently “bad” is detected (exactly what is |
| | “bad⇄ can vary and be set as part of the condition), such as |
| | sending an email to a system administrator if toner is low, if a |
| | motor in a print engine is detected as not functioning properly, |
| | etc.) |
| Reports | Date: A particular day(s) or date(s) on which the task should be |
| | performed. |
| | Time: A particular time or time period during which the task |
| | should be performed. Times may be tied to particular dates |
| | (e.g., to allow different behavior on weekends than on |
| | weekdays). |
| | Type: Which of multiple pre-defined types of reports should be |
| | run. |
| | Contents: What status information should be included in the |
| | report. |
| | Results: What should be done with the results of the report (e.g., |
| | print the results, email the results to a particular email address, |
| | collect the results locally then print out all the results at a later |
| | time (e.g., collect usage reports daily and then print out the |
| | results at the end of the week, etc.)). |
| Delayed | Date: A particular day(s) or date(s) on which the task should be |
| Print | performed. |
| Jobs | Time: A particular time or time period during which the task |
| | should be performed. Times may be tied to particular dates |
| | (e.g., to allow different behavior on weekends than on |
| | weekdays). |
| | Parameters: What parameters of the print job should trigger |
| | delaying the print job (e.g., greater than a particular number of |
| | bytes, greater than a particular number of pages, from a |
| | particular user, a user request to delay the print job, etc.). |
| | Criteria: Other criteria for determining when to print the job |
| | (e.g., print delayed jobs from smallest to biggest, print delayed |
| | jobs in chronological order based on time the jobs are received, |
| | print the job only if there are enough consumables available to |
| | print the job (e.g., there may be insufficient cyan toner or ink |
| | for color print jobs, but sufficient black toner or ink to print |
| | black and white print jobs, so color print jobs would be delayed |
| | further but black and white print jobs would print), etc.). |
| Power- | Date: A particular day(s) or date(s) on which the task should be |
| Save | performed. |
| | Time: A particular time or time period during which the task |
| | should be performed. Times may be tied to particular dates |
| | (e.g., to allow different behavior on weekends than on |
| | weekdays). |
| | Type: Which of multiple power-save modes should be entered. |
| | Criteria: Other criteria for determining whether to enter a |
| | power-save mode (e.g., could enter power-save mode only if no |
| | print jobs (other than delayed print jobs) are pending, or enter |
| | power-save mode only after all other tasks have been done |
| | (e.g., if there are three tasks to be performed at 9:00 PM and |
| | one of the tasks is enter power-save mode, then the enter |
| | power-save mode task should be the last of the three tasks to be |
| | performed), etc.). |

Thus, a wide variety of different tasks can be scheduled. For example, a task may be set up for large print jobs (e.g., greater than a threshold number of pages) to be stored on a local hard disk and subsequently printed at a later time when the printer is anticipated to be less busy (e.g., after 9:00 PM). By way of another example, a calibration cycle may be scheduled to occur if at least a threshold number of pages (e.g., 100 or 500 pages—the desired value for this number can vary by printer) have been printed since the last calibration cycle and the current time is during a period of anticipated low use (e.g., between 9:00 PM and 6:00 AM). By way of yet another example, the printer may be scheduled to go into a power-save mode at 6:00 PM on weekdays and to come out of the power-save mode at 7:00 AM on weekdays and perform a calibration cycle. By way of still another example, the printer may be scheduled to print a report of the day's log at a particular time (e.g., 11:59 PM) or prior to going into a power-save mode at the end of the day (e.g., after 6:00 PM). By way of yet another example, the printer may be scheduled to email a report of the printer's status at a particular time (e.g., 9:00 PM, 5:00 AM, etc.). By way of another example, the printer may be scheduled to run a self-diagnostic test once per month (e.g., the first day of the month). Tasks may also be scheduled in other manners via web server 134 or alternatively other modules. For example, a proprietary printer task scheduling interface may be presented to the user locally at printer 120 (e.g., via local I/O module 122). This interface may take the same form as web pages (e.g., display 200 of FIG. 3), or some other form. Alternatively, local I/O module 122 may have associated therewith a web browser that can access web server 134 analogous to web browser 144. By way of another example, the user may be able to input task scheduling requests along with submission of a print request to printer 120. A print options menu may be displayed to the user via which the user can enter scheduling requests (e.g., to treat the print request as a delayed print job, or to print one copy of the requested document immediately but to treat remaining copies of the document to be printed as delayed print jobs).

Returning to FIG. 2, printer 120 includes task scheduling data 140. The scheduled tasks (the defined rules) received by web server 134 are stored in task scheduling data 140. When new tasks are scheduled, they may be added to task scheduling data 140, or alternatively may operate to replace the current test scheduling data 140. Task scheduling data 140 may also be retrieved by web server 134 (e.g., in response to a request for a particular web page from web server 134) and incorporated into one or more web pages that can be communicated to web browser 144. This allows the current scheduled tasks to be displayed to a user of client device 142, or alternatively to a local user of printer 120.

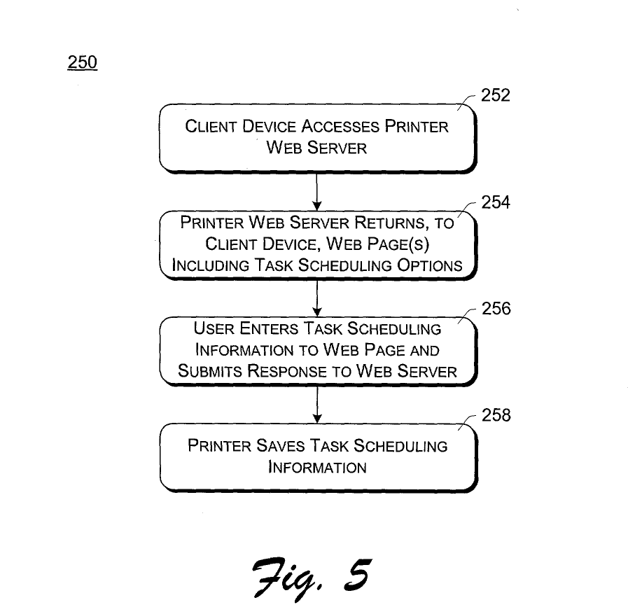

FIG. 4 illustrates an exemplary display 230 of current scheduled printer tasks for a printer (e.g., printer 120). Display 230 is a web page communicated from web server 134, analogous to the web page for display 200 of FIG. 3, except that display 230 shows currently scheduled tasks. As illustrated, two tasks are currently scheduled for the printer: a calibration cycle to be performed between 8:00 PM and 6:00 AM and if more than 50 pages have been printed since the last calibration cycle, and a report task for a system status report to be printed out at 6:00 AM on the first weekday of every week.

Display 230 also includes a delete button 232, a modify button 234, and an add button 236. A user can select (e.g., hi-light) a task listed in display 230 and delete the selected task by selecting delete button 232. A user can also select a task listed in display 230 and modify the task by selecting modify button 234 (e.g., bringing up a rule definition window analogous to window 204 of FIG. 3 via which the user can change the conditions for the rule). A user can also add a new task by selecting add button 236 (e.g., causing a web page for display 200 to be presented to the user). Indications of any modifications, deletions, or additions to the scheduled tasks via buttons 232, 234, and 236 are returned to web server 134 for storage in task scheduling data 140.

Returning to FIG. 2, printer 120 also includes a time module 136 and a scheduling module 138. Scheduling module 138 accesses task scheduling data 140 to determine which tasks are to be performed at what times, and informs the appropriate other modules of printer 120 of the particular tasks to be performed at the time they are to be performed. For example, if task scheduling data 140 indicates that it is currently time to perform a calibration cycle, then scheduling module 138 informs calibration module 128 to perform a calibration cycle. Scheduling module 138 communicates any additional information to the modules that is needed to perform the desired task (e.g., which of multiple types of calibration cycles to perform if printer 120 supports multiple types of calibration cycles, which of multiple report types to generate if printer 120 supports multiple types of reports, which of multiple files stored on a local mass storage device to print (e.g., due to a delayed print job), etc.).

Scheduling module 138 relies on knowing the approximate current time and/or current date (depending on what conditions are set for the scheduled tasks) in order to perform the scheduled tasks at the appropriate times. Scheduling module 138 obtains this time and/or date data from time module 136.

Time module 136 can operate in a wide variety of different manners. In one implementation, printer 120 includes an independently-powered (e.g., battery-powered) clock component that allows time module 136 to keep track of the current time and date even though printer 120 may have been turned off, disconnected from its AC source (e.g., unplugged), placed into a power-save mode, etc.

Alternatively, rather than adding an independently-powered clock to printer 120, time module 136 may be configured to access a remote server 146 to obtain the current time and/or date. Server 146 may be a dedicated time server whose sole responsibility is to provide the time and/or date to requesting client devices (whether they be printers, computing devices, etc.). Alternatively, server 146 may be a server (such as a Dynamic Host Configuration Protocol (DHCP) server that assigns Internet addresses to devices logging onto a TCP/IP network or some other server) that has other responsibilities and simply provides the current time and/or date as part of those responsibilities.

Printer 120 may also include power saving features that allow the printer to go into a power-save (low-power) mode in order to conserve energy. However, even when in a power-save mode, scheduled tasks can still be performed. When a scheduled task needs to be performed and printer 120 is in a power-save mode, the printer comes out of its power-save mode as needed and scheduling module 138 has the appropriate tasks performed. Once all scheduled tasks have been performed, scheduling module 138 may issue the appropriate commands to return printer 120 to its power-save mode (alternatively, scheduling module 138 may not issue such commands, and simply leave printer 120 in its normal, non-power-save, mode). It should be noted that printer 120 operates to bring itself out of the power-save mode (as necessary) to perform its own scheduled tasks—printer 120 need not rely on any external device to communicate a signal to printer 120 in order for it to bring itself out of the power-save mode.

The exact manner in which printer 120 is brought out of a power-save mode or placed into a power-save mode depends on the nature of the power-save mode. In some printers the power-save mode shuts off power to only certain components of printer 120, but keeps the controller or processor of printer 120 running. For example, in a laser printer the power-save mode may shut off power to the fuser, which is a high-energy component, but leave the processor running. In this situation, with scheduling module 138 implemented as software executed by the processor, scheduling module 138, as well as time module 136, is able to continue running and thus determine when scheduled tasks are to be performed.

However, in other printers the power-save mode may shut off power to the controller or processor as well. In this situation, with scheduling module 138 implemented as software executed by the controller or processor, scheduling module 138 is not running when printer 120 is in a power-save mode. Printer 120 however will also include one or more hardware components that sense when a request is communicated to printer 120 even though printer 120 is in a power-save mode. These hardware components can be modified to also bring the controller or processor out of its low-power mode (e.g., by issuing an interrupt) at regular or irregular intervals (e.g., every 10 milliseconds, every second, every minute, etc.). Alternatively, prior to going into power-save mode a check can be performed as to when the next scheduled task is to occur and the hardware components programmed to issue the next interrupt at the time (or just prior to the time) the next scheduled task is to occur. Once out of its low-power mode, scheduling module 138 can check whether any scheduled tasks need to be performed, and have any such tasks performed. Once any scheduled tasks that need to be performed are performed, or if no scheduled tasks need to be performed, scheduling module 138 can have the controller or processor returned to its low-power mode.

In some embodiments, power-save mode can remove power from various components of the printer (for example, the controller or processor, a stacker, a mail sorter, etc.). When a scheduled task is to be performed an interrupt is issued to the controller or processor that wakes up the controller or processor to perform the scheduled task. Any other component that needs to be running to carry out the scheduled task is also brought out of power-save, but those components that do not need to be running are not brought out of power-save. For example, if a scheduled task were to generate and email a report then the controller or processor would need to be brought out of power-save but a fuser or mail sorter would not. But, if the scheduled task were to generate and print the report, then the controller and the fuser would need to be brought out of power-save but the mail sorter would not.

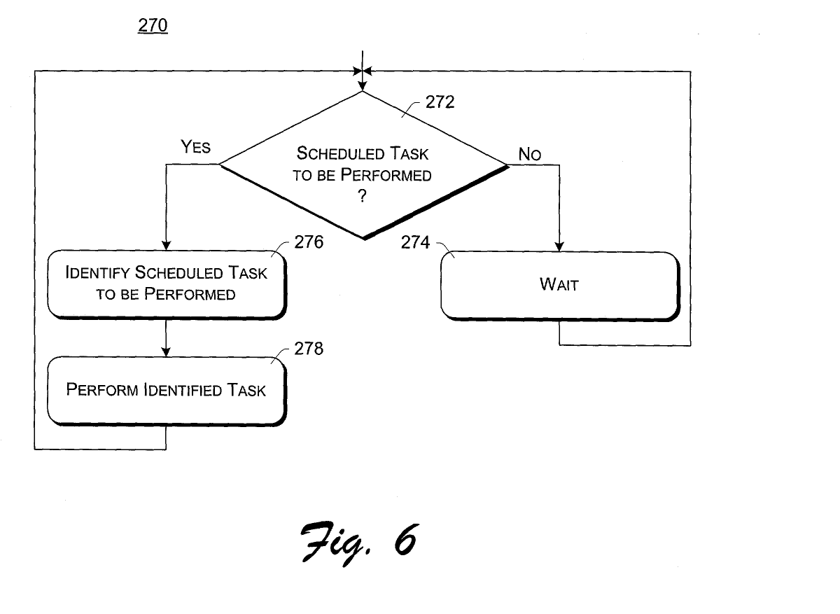

FIG. 5 is a flowchart illustrating an exemplary process 250 for scheduling printer tasks. Process 250 may be performed in software, firmware, hardware, or combinations thereof.

Initially, a client device accesses a web server of a printer for which printer tasks are to be scheduled (act 252). The web server returns, to the client device, one or more web pages including task scheduling options (act 254). A user of the client device then enters task scheduling information to the web page (e.g., in the form of rules for the tasks being scheduled and an identifier of the task associated with each rule) and the client device submits the task scheduling information to the web server (act 256). It should be noted that, depending on the implementation, multiple communications may occur between the client device and the web server in acts 252-256. Upon receipt of the task scheduling information, the printer saves the task scheduling information (act 258).

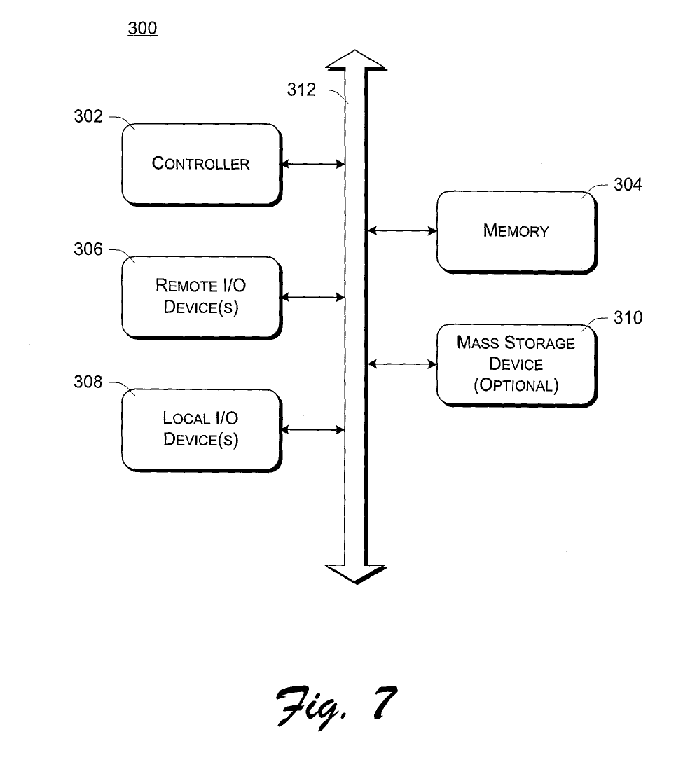

FIG. 6 is a flowchart illustrating an exemplary process 270 for performing scheduled tasks. Process 270 is implemented by printer (e.g., printer 120 of FIG. 2), and may be performed in software, firmware, hardware, or combinations thereof.

Initially, the printer checks whether a scheduled task is to be performed at the current time (act 272). The printer wakes itself up (brings itself out of a power-save mode as necessary) in order to perform the check of act 272. This check is made based on the task scheduling information saved at the printer, as well as the current time, the current date, and/or other conditions defined in the rules of the scheduling information. A check is made as to whether any of the rules in task scheduling data 140 have all of their conditions satisfied at the current time. If no scheduled task is to be performed at the current time, the printer waits for an amount of time (act 274), then again checks whether a scheduled task is to be performed at the then current time (act 272).

However, if one or more scheduled tasks are to be performed the current time, then one of the scheduled tasks to be performed is identified (act 276) and performed (act 278). If multiple tasks are scheduled to be performed at the same time, the order in which printer 120 is to perform them can be determined in a variety of different manners (e.g., by a pre-determined ordering associated with the various tasks (e.g., self-diagnostic tests are performed before reports are generated), in an order identified by the user that created the tasks, randomly, etc.). Process 270 then returns to check whether a scheduled task is to be performed at the then current time (act 272).

FIG. 7 illustrates portions of an exemplary device 300 in additional detail. Device 300 can be, for example, a computing device 102 or printer 104 of FIG. 1, or printer 120 of FIG. 2. Device 300 includes a processor or controller 302, a memory 304, a remote I/O device(s) 306, a local I/O device(s) 308, and an optional mass storage device 310, all coupled to a bus 312. Depending on the type of the device, various additional conventional components may also be typically included in device 300 (e.g., a printer will typically include a print engine, print media inputs and outputs, etc.).

Controller or processor 302 can be a general purpose microprocessor or a dedicated microcontroller (e.g., one or more Application Specific Integrated Circuits (ASICs) or programmable logic devices (PLDs)). Remote I/O device(s) 306 is one or more conventional interface devices allowing components of device 300 (e.g., controller 302) to communicate with other devices external to device 300. Remote I/O device(s) 306 may include, for example, a modem, a network interface card (NIC), a parallel port, a serial port, a universal serial bus (USB) port, and so forth. Local I/O device(s) 308 is an interface device allowing local commands and/or data to be input to and/or output from device 300. Local I/O device(s) 308 may include, for example, a display device (e.g., liquid crystal display (LCD), light emitting diode (LED), etc.), a keypad (e.g., alphanumeric or otherwise), a touchscreen, a cursor control device (e.g., a trackpad, trackball, etc.), print media handlers and printing components (e.g., ink or toner dispensers), and so forth.

Bus 312 represents one or more buses in printer 300, which may be implemented in accordance with public and/or proprietary protocols. The bus architecture can vary by printer as well as by manufacturer. Mass storage device 310 is optional and represents any of a wide variety of conventional storage devices, such as fixed or removable magnetic or optical disks, Flash memory, etc.

Memory 304 represents volatile and/or nonvolatile memory used to store instructions and data for use by controller or processor 302. Typically, instructions are stored on a mass storage device 310 (or nonvolatile memory portion of memory 304) and loaded into a volatile memory portion of memory 304 for execution by controller or processor 302. Additional memory components may also be involved, such as cache memories internal or external to controller or processor 302. Various embodiments of the invention may be implemented, at different times, in any of a variety of computer readable media that is part of, or readable by, device 300. For example, such computer readable media may be mass storage device 310, memory 304, a cache memory, media (e.g., a magnetic or optical disk) accessible to device 300, and so forth.

Device 300 is exemplary only. It is to be appreciated that additional components (not shown) can be included in device 300 and some components illustrated in device 300 need not be included. For example, additional processors or storage devices, additional I/O interfaces, and so forth may be included in device 300, or mass storage device 310 may not be included.

Various discussions herein refer to components and modules that can be implemented in a printer or computing device. It is to be appreciated that the components and processes described herein can be implemented in software, firmware, hardware, or combinations thereof. By way of example, a programmable logic device (PLD) or application specific integrated circuit (ASIC) could be configured or designed to implement various components and/or processes discussed herein.

Although the description above uses language that is specific to structural features and/or methodological acts, it is to be understood that the invention defined in the appended claims is not limited to the specific features or acts described. Rather, the specific features and acts are disclosed as exemplary forms of implementing the present invention.

1. One or more computer readable media having stored thereon a plurality of instructions that, when executed by one or more controllers of a printer, causes the one or more controllers to:
check whether one or more tasks need to be performed by the printer, wherein each of the one or more tasks was previously scheduled; and
if one or more tasks need to be performed, then,
identify one of the one or more tasks, and
perform the identified task.

2. One or more computer readable media as recited in claim 1, wherein the instructions further cause the one or more controllers to repeatedly check, at regular intervals, whether one or more tasks need to be performed by the printer.

3. One or more computer readable media as recited in claim 1, wherein the instructions that cause the one or more controllers to check whether one or more tasks need to be performed further cause the one or more controllers to identify a current time and a current date.

4. One or more computer readable media as recited in claim 1, wherein the one or more tasks include a printer calibration cycle task.

5. One or more computer readable media as recited in claim 1, wherein the one or more tasks include a self-diagnostic test task.

6. One or more computer readable media as recited in claim 1, wherein the one or more tasks include a report generation task.

7. One or more computer readable media as recited in claim 1, wherein the one or more tasks include a delayed print task.

8. One or more computer readable media as recited in claim 1, wherein the instructions that cause the one or more controllers to check whether one or more tasks need to be performed further cause the one or more controllers to:
access task scheduling data including a plurality of rules, each of the plurality of rules including one or more conditions;
for each rule, check whether each condition of the rule is currently satisfied;
determine a set of rules for which each condition of the rule is satisfied; and
identify, as the one or more tasks, the task associated with each rule in the set of rules.

9. A method, implemented in a printer, the method comprising:
checking whether one or more tasks need to be performed by the printer, wherein each of the one or more tasks was previously scheduled; and
if one or more tasks need to be performed, then,
identifying one of the one or more tasks, and
performing the identified task.

10. A method as recited in claim 9, wherein the one or more tasks include a printer calibration cycle task.

11. A method as recited in claim 9, further comprising coming out of a power-save mode to perform the checking.

12. A method as recited in claim 11, wherein the coming out comprises coming out of the power-save mode not in response to an external device.

13. A method as recited in claim 9, further comprising:
coming out of a power-save mode to perform the checking;
if no tasks need to be performed then returning to the power-save mode; and
if one or more tasks need to be performed then returning to the power-save mode after performing each of the one or more tasks.

14. A method as recited in claim 9, wherein checking whether one or more tasks need to be performed comprises:
accessing task scheduling data including a plurality of rules, each of the plurality of rules including one or more conditions;
for each rule, checking whether each condition of the rule is currently satisfied;
determining a set of rules for which each condition of the rule is satisfied; and
identifying, as the one or more tasks, the task associated with each rule in the set of rules.

15. One or more computer readable media having stored thereon a plurality of instructions that, when executed by one or more processors of a printer, causes the one or more processors to:
receive a request to schedule one or more tasks to be automatically performed by the printer;
communicate task scheduling options to the requestor;
receive task scheduling information from the requestor; and
save the task scheduling information for subsequent automatic performance of the scheduled tasks identified by the task scheduling information.

16. One or more computer readable media as recited in claim 15, wherein the plurality of instructions further cause the one or more processors to detect when scheduled tasks need to be performed and automatically perform the scheduled tasks when they need to be performed.

17. One or more computer readable media as recited in claim 15, wherein the scheduling information includes one or more rules each having one or more conditions.

18. One or more computer readable media as recited in claim 15, wherein the instructions that cause the one or more processors to communicate task scheduling options to the requester comprise instructions that cause the one or more processors to communicate a web page to the requestor.

19. One or more computer readable media as recited in claim 15, wherein the instructions further cause the one or more processors to:
receive a request to modify one or more scheduled tasks; and
communicate a web page allowing the task scheduling information to be modified.

20. One or more computer readable media as recited in claim 15, wherein the instructions further cause the one or more processors to:
receive a request to delete one or more scheduled tasks; and
communicate a web page allowing the task scheduling information to be deleted.

21. One or more computer readable media as recited in claim 15, wherein the requestor comprises a remote computing device.

22. A method comprising:
receiving a request to schedule one or more tasks to be automatically performed by a printer;
communicating task scheduling options to the requestor;
receiving task scheduling information from the requestor; and
saving the task scheduling information for subsequent automatic performance of the scheduled tasks identified by the task scheduling information.

23. A method as recited in claim 22, further comprising:
detecting when scheduled tasks need to be performed; and
automatically performing the scheduled tasks when they need to be performed.

24. A method as recited in claim 22, wherein communicating comprises communicating a web page to the requester.

25. A method as recited in claim 22, wherein the scheduling information includes one or more rules each having one or more conditions.

26. One or more computer readable media having stored thereon a plurality of instructions that, when executed by one or more processors of a printer, causes the one or more processors to:
provide one or more web pages to a remote computing device, the one or more web pages including task scheduling options;
receive task scheduling information from the remote computing device;
save the task scheduling information; and
subsequently perform the scheduled tasks in accordance with the task scheduling information.

27. One or more computer readable media as recited in claim 26, wherein the scheduling information includes one or more rules each having one or more conditions.

28. A system comprising:
a web server configured to,
serve one or more web pages to a requester, the one or more web
pages including task scheduling options,
receive task scheduling information from the requestor, and
save the received task scheduling information; and
a scheduling module configured to,
access the saved task scheduling information, and
have the scheduled tasks performed at the scheduled time.

29. A method, implemented on a printer, the method comprising:
receiving, from a requester, a request to schedule one or more tasks to be automatically performed by the printer;
communicating task scheduling options to the requestor;
receiving task scheduling information from the requestor;
saving the received task scheduling information;
allowing the printer to enter a power-save mode;
subsequently coming out of the power-save mode in order to perform at least one of the scheduled tasks;
having the at least one scheduled task performed; and
allowing the printer to return to the power-save mode upon completion of the at least one scheduled task.

30. The method as recited in claim 29, wherein the requestor comprises a remote computing device.
